(19) United States
(12) Patent Application Publication
(10) Pub. No.: US 2026/0214716 A1
(43) Pub. Date: Jul. 23, 2026

(54) SIGNALING FOR LOW POWER RADIO

(71) Applicant: QUALCOMM INCORPORATED, San Diego, CA (US)

(72) Inventors: Ahmed ELSHAFIE, San Diego, CA (US); Huilin XU, Beijing (CN); Linhai HE, San Diego, CA (US); Wanshi CHEN, San Diego, CA (US); Hung Dinh LY, San Diego, CA (US); Yuchul KIM, San Diego, CA (US); Peter GAAL, San Diego, CA (US); Chao WEI, Beijing (CN); Wei YANG, San Diego, CA (US)

(21) Appl. No.: 19/137,445

(22) PCT Filed: Feb. 7, 2023
(86) PCT No.: PCT/CN2023/074756

§ 371 Date: Jun. 10, 2025

(51) Int. Cl. H04W 74/0833; H04B 7/06; H04W 52/36

(52) U.S. Cl. CPC H04W 74/0833; H04B 7/06968; H04W 52/367

(57) ABSTRACT

Various aspects of the present disclosure generally relate to wireless communication. In some aspects, a user equipment (UE) may receive, at a second radio of the UE, an indication to perform a random access channel (RACH) procedure using a first radio of the UE or the second radio, wherein the second radio operates at a lower power than the first radio. The UE may perform the RACH procedure based at least in part on the indication. Numerous other aspects are described.

### FIELD OF THE DISCLOSURE

Aspects of the present disclosure generally relate to wireless communication and to techniques and apparatuses for signaling a low power radio.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, at a second radio of the UE, an indication to perform a random access channel (RACH) procedure using a first radio of the UE or the second radio, where the second radio operates at a lower power than the first radio. The method may include performing the RACH procedure based at least in part on the indication.

Some aspects described herein relate to a method of wireless communication performed by a network entity. The method may include transmitting an indication to perform a RACH procedure using a low power radio. The method may include performing the RACH procedure based at least in part on the indication.

Some aspects described herein relate to a method of wireless communication performed by a UE. The method may include receiving a signal configuration for using a second radio of the UE that operates at a lower power than a first radio of the UE. The method may include communicating using the first radio or the second radio based at least in part on the signal configuration.

Some aspects described herein relate to a method of wireless communication performed by a network entity. The method may include transmitting a signal configuration that indicates one or more of paging occasions or a tracking reference signal resource set for use with a low power radio. The method may include communicating based at least in part on the signal configuration.

Some aspects described herein relate to a UE for wireless communication. The UE may include a memory and one or more processors coupled to the memory. The one or more processors may be configured to receive, at a second radio of the UE, an indication to perform a RACH procedure using a first radio of the UE or the second radio, where the second radio operates at a lower power than the first radio. The one or more processors may be configured to perform the RACH procedure based at least in part on the indication.

Some aspects described herein relate to a network entity for wireless communication. The network entity may include a memory and one or more processors coupled to the memory. The one or more processors may be configured to transmit an indication to perform a RACH procedure using a low power radio. The one or more processors may be configured to perform the RACH procedure based at least in part on the indication.

Some aspects described herein relate to a UE for wireless communication. The UE may include a memory and one or more processors coupled to the memory. The one or more processors may be configured to receive a signal configuration for using a second radio of the UE that operates at a lower power than a first radio of the UE. The one or more processors may be configured to communicate using the first radio or the second radio based at least in part on the signal configuration.

Some aspects described herein relate to a network entity for wireless communication. The network entity may include a memory and one or more processors coupled to the memory. The one or more processors may be configured to transmit a signal configuration that indicates one or more of paging occasions or a tracking reference signal resource set for use with a low power radio. The one or more processors may be configured to communicate based at least in part on the signal configuration.

Some aspects described herein relate to a non-transitory computer-readable medium that stores a set of instructions for wireless communication by a UE. The set of instructions, when executed by one or more processors of the UE, may cause the UE to receive, at a second radio of the UE, an indication to perform a RACH procedure using a first radio of the UE or the second radio, where the second radio operates at a lower power than the first radio. The set of instructions, when executed by one or more processors of the UE, may cause the UE to perform the RACH procedure based at least in part on the indication.

Some aspects described herein relate to a non-transitory computer-readable medium that stores a set of instructions for wireless communication by a network entity. The set of instructions, when executed by one or more processors of the network entity, may cause the network entity to transmit an indication to perform a RACH procedure using a low power radio. The set of instructions, when executed by one or more processors of the network entity, may cause the network entity to perform the RACH procedure based at least in part on the indication.

Some aspects described herein relate to a non-transitory computer-readable medium that stores a set of instructions for wireless communication by a UE. The set of instructions, when executed by one or more processors of the UE, may cause the UE to receive a signal configuration for using a second radio of the UE that operates at a lower power than a first radio of the UE. The set of instructions, when executed by one or more processors of the UE, may cause the UE to communicate using the first radio or the second radio based at least in part on the signal configuration.

Some aspects described herein relate to a non-transitory computer-readable medium that stores a set of instructions for wireless communication by a network entity. The set of instructions, when executed by one or more processors of the network entity, may cause the network entity to transmit a signal configuration that indicates one or more of paging occasions or a tracking reference signal resource set for use with a low power radio. The set of instructions, when executed by one or more processors of the network entity, may cause the network entity to communicate based at least in part on the signal configuration.

Some aspects described herein relate to an apparatus for wireless communication. The apparatus may include means for receiving, at a second radio of the apparatus, an indication to perform a RACH procedure using a first radio of the apparatus or the second radio, where the second radio operates at a lower power than the first radio. The apparatus may include means for performing the RACH procedure based at least in part on the indication.

Some aspects described herein relate to an apparatus for wireless communication. The apparatus may include means for transmitting an indication to perform a RACH procedure using a low power radio. The apparatus may include means for performing the RACH procedure based at least in part on the indication.

Some aspects described herein relate to an apparatus for wireless communication. The apparatus may include means for receiving a signal configuration for using a second radio of the apparatus that operates at a lower power than a first radio of the apparatus. The apparatus may include means for communicating using the first radio or the second radio based at least in part on the signal configuration.

Some aspects described herein relate to an apparatus for wireless communication. The apparatus may include means for transmitting a signal configuration that indicates one or more of paging occasions or a tracking reference signal resource set for use with a low power radio. The apparatus may include means for communicating based at least in part on the signal configuration.

Aspects generally include a method, apparatus, system, computer program product, non-transitory computer-readable medium, UE, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a four-step random access procedure, in accordance with the present disclosure.

FIG. 5 is a diagram illustrating an example of a two-step random access procedure, in accordance with the present disclosure.

FIG. 6 is a diagram illustrating an example of a physical downlink control channel order, in accordance with the present disclosure.

FIG. 7 is a diagram illustrating an example of a low power (LP) wake up receiver (WUR), in accordance with the present disclosure.

FIG. 8 is a diagram illustrating an example of using an LP WUR for additional functionality, in accordance with the present disclosure.

FIG. 9 is a diagram illustrating an example of using signal configuration for an LP WUR, in accordance with the present disclosure.

FIG. 10 is a diagram illustrating an example process performed, for example, by a UE, in accordance with the present disclosure.

FIG. 11 is a diagram illustrating an example process performed, for example, by a network entity, in accordance with the present disclosure.

FIG. 12 is a diagram illustrating an example process performed, for example, by a UE, in accordance with the present disclosure.

FIG. 13 is a diagram illustrating an example process performed, for example, by a network entity, in accordance with the present disclosure.

FIG. 14 is a diagram of an example apparatus for wireless communication, in accordance with the present disclosure.

FIG. 15 is a diagram of an example apparatus for wireless communication, in accordance with the present disclosure.

### DETAILED DESCRIPTION

A user equipment (UE) may have limited radio frequency (RF) capabilities, or fewer RF capabilities than an enhanced UE, such as a smartphone with full RF capabilities. The UE may have a low-power (LP) wake-up radio (WUR) (also known as an LP wake-up receiver or an LP wake-up radio receiver). According to one or more examples, the LP WUR may be configured to detect a wake up signal (WUS) but not perform other communications. The WUS may be a signal (e.g., a sequence of bits) configured to wake up the UE. The WUS may be an LP WUS configured to specifically wake up an LP WUR. The LP WUR may have an operating power that does not exceed a threshold that is configured for LP WURs. The UE may have a main radio that is configured to perform communications and that has a greater operating power than the LP WUR. When the UE operates the LP WUR and not the main radio, the UE may conserve power in a sleep state and expend less power monitoring for a WUS. When the WUS is detected, the UE may wake up the main radio, which is able to perform other functions such as monitoring for physical downlink control channel (PDCCH) communications and other communications, such as exchanging data. Sleeping may involve turning off a radio and one or more other components or functions of the UE. Turning off or switching off a radio may include removing power from the radio such that the radio is not fully operating or operating with full power. Waking up may involve turning on a radio and one or more other components or functions of the UE. Turning on or switching on a radio may include adding power to the radio such that the radio is fully operating or operating with full power.

In an inactive mode, the UE may be asked to perform a random access channel (RACH) procedure and/or paging monitoring. According to various aspects described herein, if the UE is already in a deep sleep and operating its LP WUR, the LP WUR may be used to initiate and/or perform the RACH procedure. The UE may use the LP WUR to transmit and receive some RACH signaling. For example, the UE may receive, at the LP WUR, an indication to perform a RACH procedure using the LP WUR. The UE may perform the RACH procedure based at least in part on the indication and perform the RACH procedure using the LP WUR. By using the LP WUR for additional functionality, such as for RACH procedures, the UE may conserve more power.

In some aspects, the LP WUR may perform other operations based at least in part on a signal configuration for the LP WUR. For example, the LP WUR may receive a signal configuration that configures the LP WUR to monitor for a paging indication from a network entity while the main radio is off for UE power savings. That is, the LP WUR may operate with the UE in an inactive mode to utilize additional receive and transmit functionalities (e.g., RACH, paging monitoring, tracking reference signal (TRS) availability) for more efficient power reduction.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

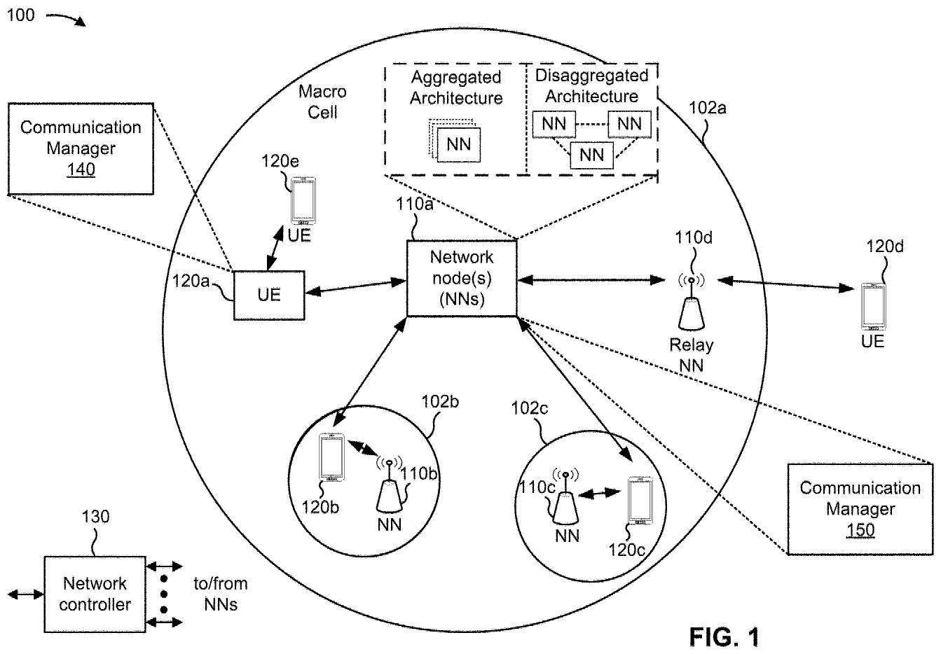

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, at a second radio of the UE, an indication to perform a RACH procedure using a first radio of the UE or the second radio, where the second radio operates at a lower power than the first radio. The communication manager 140 may perform the RACH procedure based at least in part on the indication.

In some aspects, the communication manager 140 may receive a signal configuration for using a second radio of the UE that operates at a lower power than a first radio of the UE. The communication manager 140 may communicate using the first radio or the second radio based at least in part on the signal configuration. Additionally, or alternatively, the communication manager 140 may perform one or more other operations described herein.

In some aspects, a network entity (e.g., network node 110) may include a communication manager 150. As described in more detail elsewhere herein, the communication manager 150 may transmit an indication to perform a RACH procedure using a low power radio. The communication manager 150 may perform the RACH procedure based at least in part on the indication.

In some aspects, the communication manager 150 may transmit a signal configuration that indicates one or more of paging occasions or a TRS resource set for use with a low power radio. The communication manager 150 may communicate based at least in part on the signal configuration. Additionally, or alternatively, the communication manager 150 may perform one or more other operations described herein.

As indicated above, FIG. 1 is provided as an example. Other examples may differ from what is described with regard to FIG. 1.

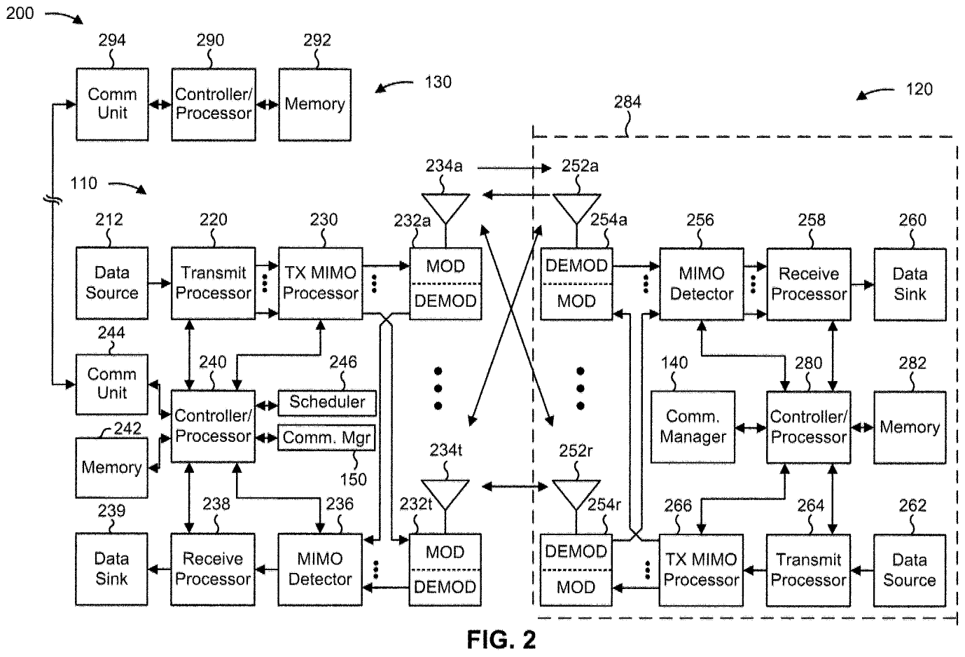

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

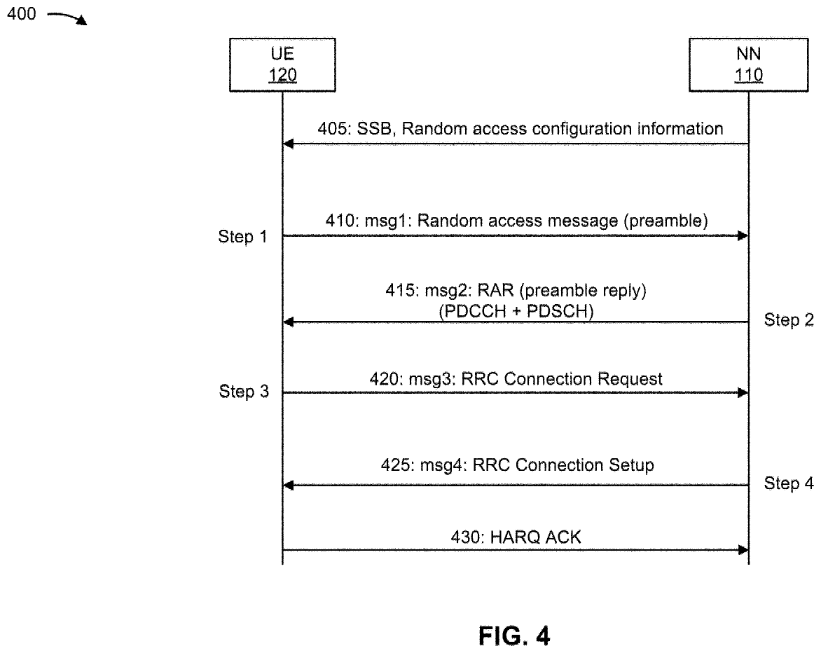

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-13).

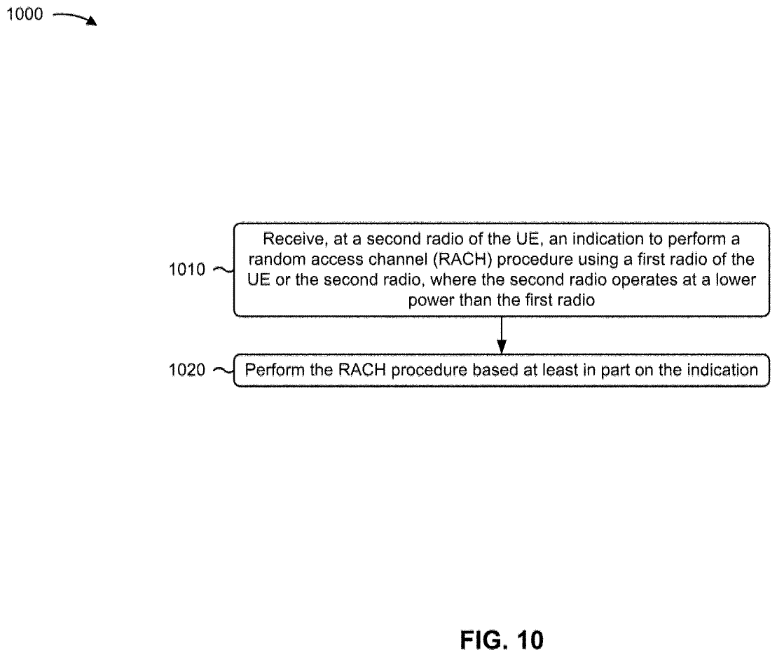

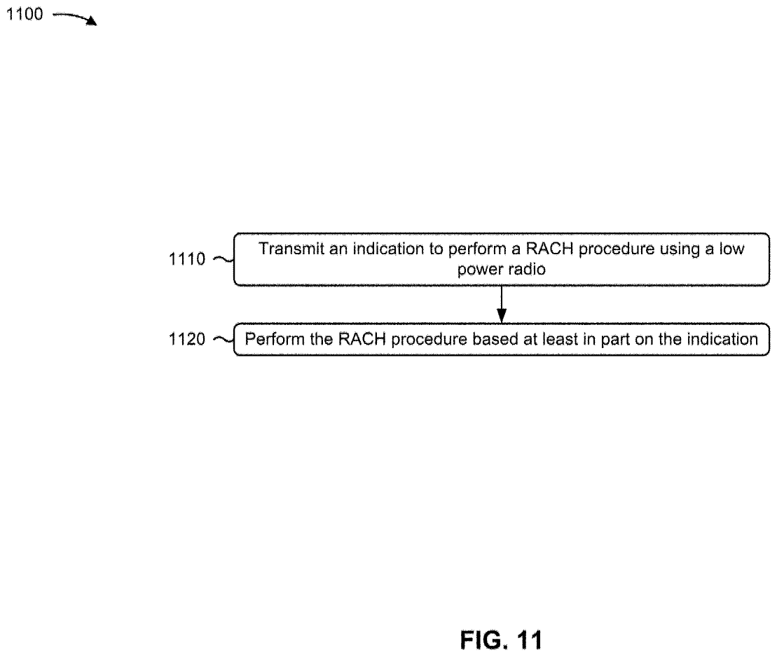

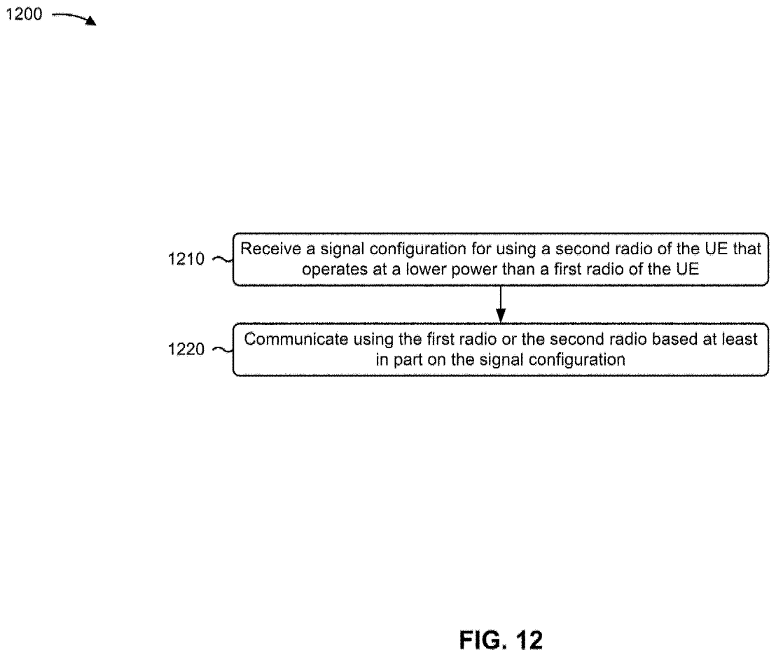

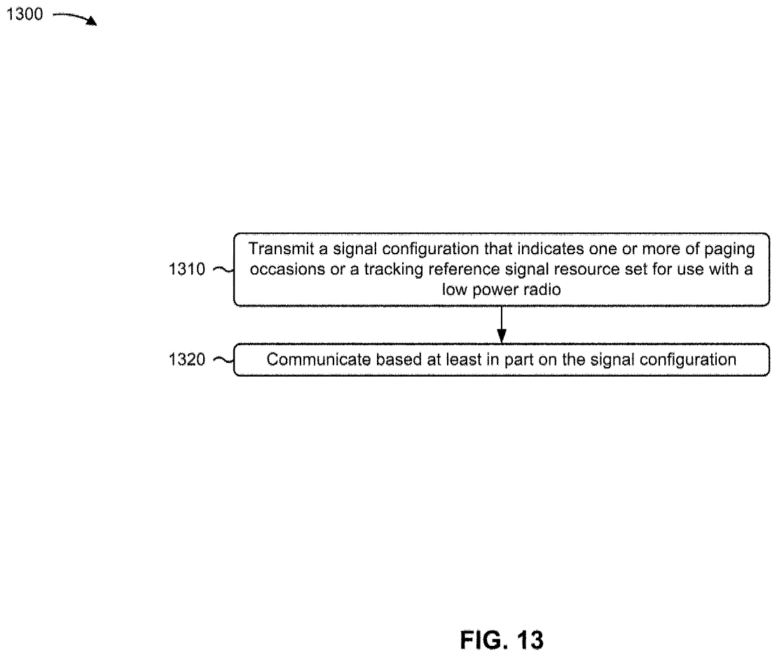

A controller/processor of a network entity (e.g., controller/processor 240 of the network node 110), the controller/processor 280 of the UE 120, and/or any other component(s) of FIG. 2 may perform one or more techniques associated with signaling an LP WUR for additional functionality, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, process 1200 of FIG. 12, process 1300 of FIG. 13, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, at a second radio of the UE, an indication to perform a RACH procedure using a first radio of the UE or the second radio, where the second radio operates at a lower power than the first radio; and/or means for performing the RACH procedure based at least in part on the indication. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a UE (e.g., UE 120) includes means for receiving a signal configuration for using a second radio of the UE that operates at a lower power than a first radio of the UE; and/or means for communicating using the first radio or the second radio based at least in part on the signal configuration.

In some aspects, a network entity (e.g., network node 110) includes means for transmitting an indication to perform a RACH procedure using a low power radio; and/or means for performing the RACH procedure based at least in part on the indication. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a network entity (e.g., network node 110) includes means for transmitting a signal configuration that indicates one or more of paging occasions or a TRS resource set for use with a low power radio; and/or means for communicating based at least in part on the signal configuration. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

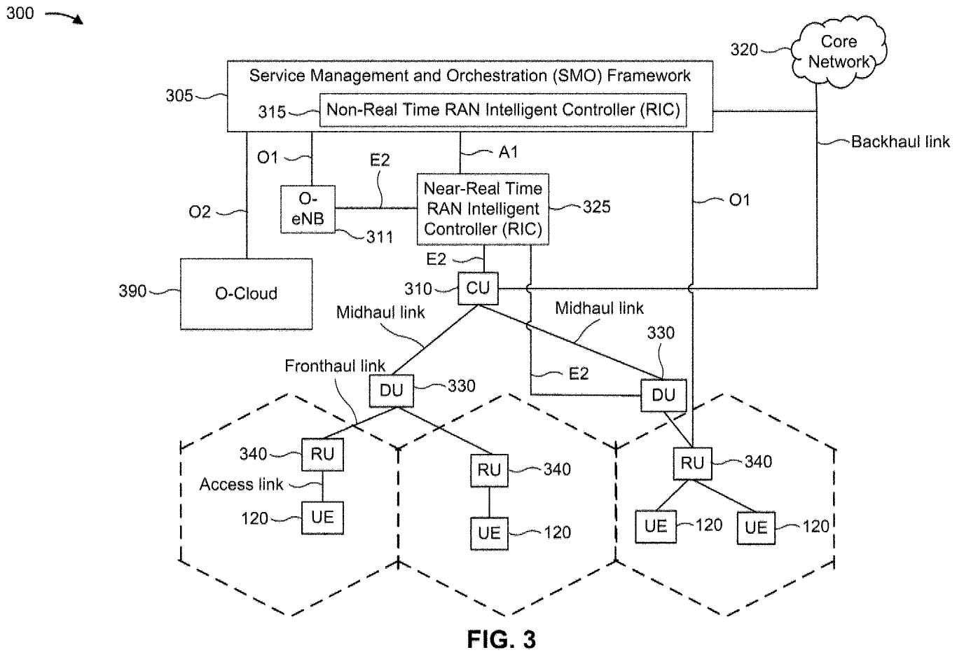

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of a four-step random access procedure, in accordance with the present disclosure. As shown in FIG. 4, a network entity (e.g., network node 110) and a UE (e.g., UE 120) may communicate with one another to perform the four-step random access procedure.

As shown by reference number 405, the network node 110 may transmit, and the UE 120 may receive, one or more synchronization signal blocks (SSBs) and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the random access procedure, such as one or more parameters for transmitting a random access message (RAM) and/or one or more parameters for receiving a random access response (RAR).

As shown by reference number 410, the UE 120 may transmit a RAM, which may include a preamble (sometimes referred to as a random access preamble, a physical RACH (PRACH) preamble, or a RAM preamble). The message that includes the preamble may be referred to as a message 1, msg1, MSG1, a first message, or an initial message in a four-step random access procedure. The random access message may include a random access preamble identifier.

As shown by reference number 415, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a physical downlink shared channel (PDSCH) communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 420, the UE 120 may transmit an RRC connection request message. The RRC connection request message may be referred to as message 3, msg3, MSG3, or a third message of a four-step random access procedure. In some aspects, the RRC connection request may include a UE identifier, uplink control information (UCI), and/or a physical uplink shared channel (PUSCH) communication (e.g., an RRC connection request).

As shown by reference number 425, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 430, if the UE 120 successfully receives the RRC connection setup message, the UE 120 may transmit a hybrid automatic repeat request (HARQ) acknowledgement (ACK).

As indicated above, FIG. 4 is provided as an example. Other examples may differ from what is described with regard to FIG. 4.

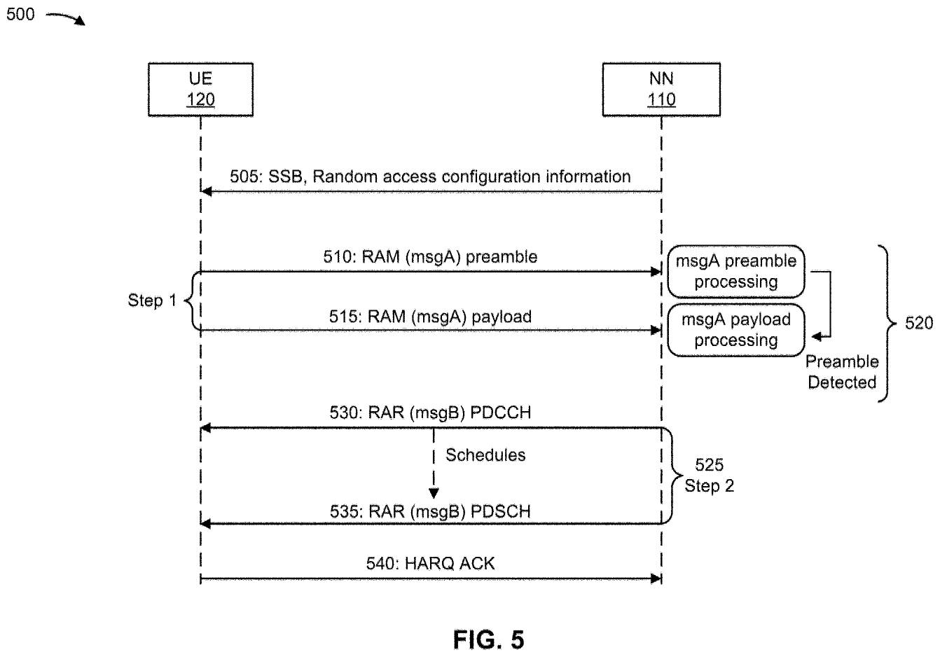

FIG. 5 is a diagram illustrating an example 500 of a two-step random access procedure, in accordance with the present disclosure. As shown in FIG. 5, a network node 110 and a UE 120 may communicate with one another to perform the two-step random access procedure.

As shown by reference number 505, the network node 110 may transmit, and the UE 120 may receive, one or more SSBs and random access configuration information. In some aspects, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the two-step random access procedure, such as one or more parameters for transmitting an RAM and/or receiving an RAR to the RAM.

As shown by reference number 510, the UE 120 may transmit, and the network node 110 may receive, a RAM preamble. As shown by reference number 515, the UE 120 may transmit, and the network node 110 may receive, a RAM payload. As shown, the UE 120 may transmit the RAM preamble and the RAM payload to the network node 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, UCI, and/or a PUSCH transmission).

As shown by reference number 520, the network node 110 may receive the RAM preamble transmitted by the UE 120. If the network node 110 successfully receives and decodes the RAM preamble, the network node 110 may then receive and decode the RAM payload.

As shown by reference number 525, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, and/or contention resolution information.

As shown by reference number 530, as part of the second step of the two-step random access procedure, the network node 110 may transmit a PDCCH communication for the RAR. The PDCCH communication may schedule a PDSCH communication that includes the RAR. For example, the PDCCH communication may indicate a resource allocation (e.g., in downlink control information (DCI)) for the PDSCH communication.

As shown by reference number 535, as part of the second step of the two-step random access procedure, the network node 110 may transmit the PDSCH communication for the RAR, as scheduled by the PDCCH communication. The RAR may be included in a MAC PDU of the PDSCH communication. As shown by reference number 540, if the UE 120 successfully receives the RAR, the UE 120 may transmit a HARQ ACK.

As indicated above, FIG. 5 is provided as an example. Other examples may differ from what is described with regard to FIG. 5.

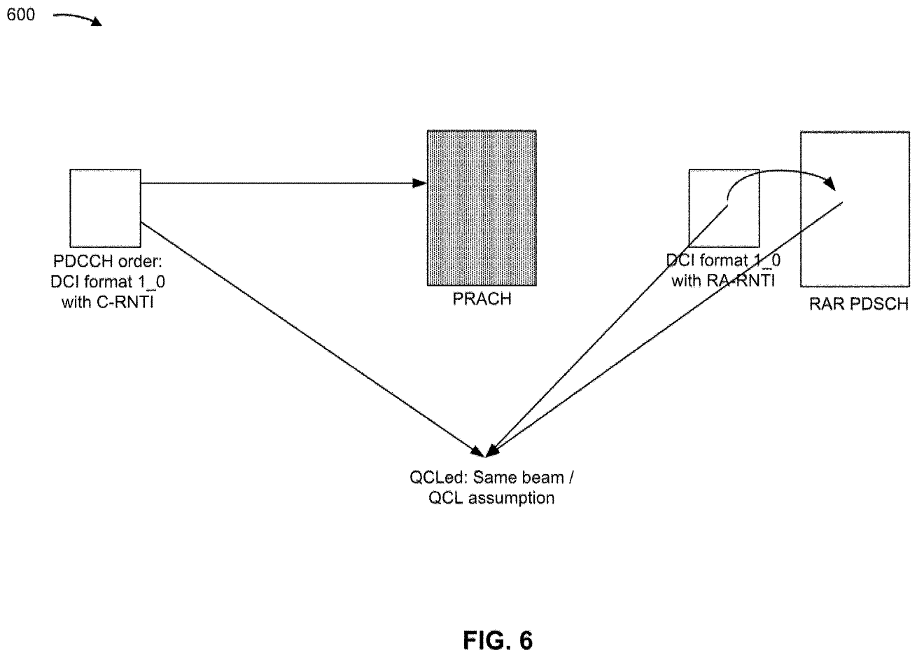

FIG. 6 is a diagram illustrating an example 600 of a PDCCH order, in accordance with the present disclosure.

A potential control region of a time and frequency resource for wireless transmission may be referred to as a control resource set (CORESET). A CORESET may be structured to support an efficient use of resources, such as by flexible configuration or reconfiguration of resources of the CORESET for one or more physical PDCCHs and/or one or more PDSCHs. In some aspects, the CORESET may occupy the first symbol of a slot, the first two symbols of a slot, or the first three symbols of a slot. A search space may include all possible locations (e.g., in time and/or frequency) where a PDCCH may be located. A CORESET may include one or more search spaces, such as a UE-specific search space, a group-common search space, and/or a common search space. One or more search spaces may be referred to as a search space (SS) set.

A UE may be configured with multiple CORESETs in a bandwidth part (BWP) of a serving cell or component carrier (CC). Each CORESET may be associated with one active transmission configuration indicator (TCI) state. A TCI state may indicate a directionality or a characteristic of the downlink beam, such as one or more quasi-co-location (QCL) properties of the downlink beam. A QCL property may include, for example, a Doppler shift, a Doppler spread, an average delay, a delay spread, or spatial receive parameters, among other examples. In some examples, each network entity transmit beam may be associated with an SSB, and the UE may indicate a preferred network entity transmit beam by transmitting uplink transmissions in resources of the SSB that are associated with the preferred transmit beam. A particular SSB may have an associated TCI state (for example, for an antenna port or for beamforming). The network entity may, in some examples, indicate a downlink network entity transmit beam based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples).

In 3GPP standards Releases 15 and 16, a CORESET configuration may indicate (e.g., via an RRC message) resource blocks (RBs) of a CORESET in a frequency domain and/or a quantity of symbols of the CORESET. Each SS set is associated with one CORESET, and there can be up to 10 SS sets in a BWP of the CC. As part of the SS set configurations, the following are RRC-configured: the associated CORESET, monitoring slots periodicity and offset, monitoring symbols with slot (determine PDCCH monitoring occasions of the SS set), an SS set type (e.g., common SS (CSS) or UE-specific SS (USS)), DCI formats to monitor, and/or a quantity of PDCCH candidates for a given aggregation level. PDCCH candidates are defined as part of SS set configurations. A PDCCH candidate with a given aggregation level and a given candidate index is defined in a given SS set. A DCI is received in one PDCCH candidate. The UE monitors PDCCH candidates in SS sets, and one or more candidates with a cyclic redundancy check (CRC) pass (successful decoding) correspond to a decoded DCI, which the UE blindly decodes.

In 3GPP standards Release 15, the PDCCH order may request a random access (RA) procedure. As shown by example 600, the PDCCH order may be transmitted using DCI format 1_0 with a cell radio network temporary identifier (CRNTI). The UE may determine that the DCI corresponds to a PDCCH order if a frequency domain resource allocation (FDRA) field of the DCI is set to all 1's, in which case the DCI indicates an RA preamble index (6 bits). If the RA preamble index is 0, then the DCI triggers a contention-based random access (CBRA) RACH procedure. In this case, the remaining fields are ignored. Otherwise, the DCI triggers a contention-free random access (CFRA) RACH procedure. The DCI may include an uplink or supplemental uplink indication (1 bit), an SSB index (6 bits), and a PRACH mask index (4 bits), and the rest of the bits are reserved.

Example 600 further shows that the UE may transmit the PRACH in the indicated RACH occasion (in the case of CFRA) or in a RACH occasion associated with a measured SSB (in the case of CBRA). After the PRACH transmission, the UE may monitor for a PDCCH with a CRC that is scrambled with an RA-RNTI (DCI format 1_0) and that schedules the RAR PDSCH. Example 600 also shows that when the CFRA is on the primary cell (PCell) or the primary secondary cell (PSCell), the UE may expect that the PDCCH scrambled with the RA-RNTI is QCLed with the PDCCH order. Also, the UE may expect that the RAR PDSCH is QCLed with the PDCCH order.

As indicated above, FIG. 6 is provided as an example. Other examples may differ from what is described with regard to FIG. 6.

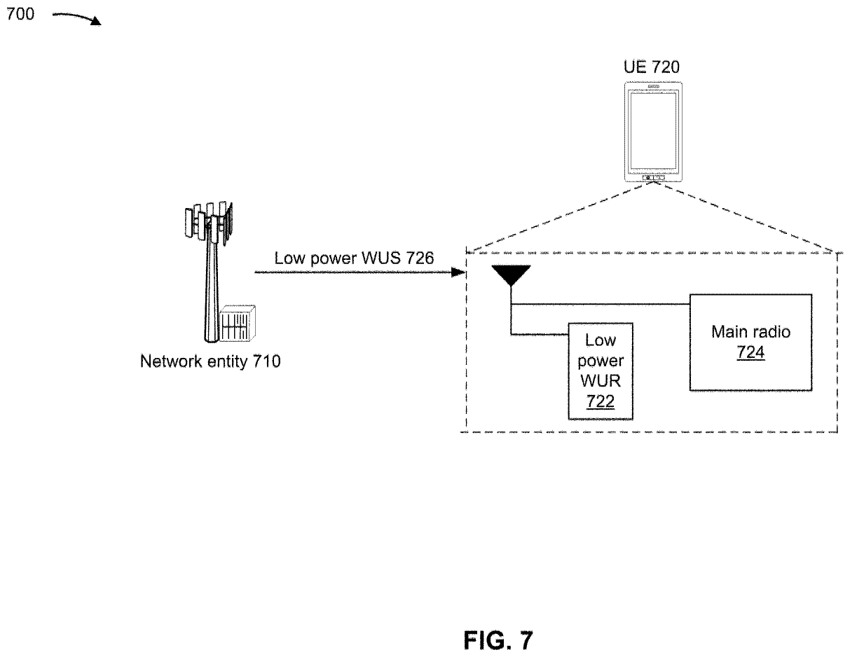

FIG. 7 is a diagram illustrating an example 700 of an LP WUR, in accordance with the present disclosure.

A network entity 710 (e.g., network node 110) and a UE 720 (e.g., a UE 120) may communicate with each other on one or more carriers via wireless network (e.g., wireless network 100). The UE 720 may include an LP WUR 722 and a main radio 724 (also referred to as a main radio receiver). The LP WUR 722 may be applicable to scenarios with on-demand low-latency and low-power (e.g., actuator, tracking, sensing). The LP WUR 722 can reduce power consumption while meeting a latency requirement by frequently monitoring for wake up indications from the network entity 710 while the main radio 724 is in an ultra-low-power sleep state.

The UE 720 may continuously monitor for a WUS with the LP WUR 722. The WUS may be an LP WUS 726 that is configured for an LP WUR. Once the WUS is detected, the UE 720 may switch on the main radio 724 to communicate with the network entity 710. For example, the UE 720 may turn off the LP WUR 722 and use the main radio 724 to receive the scheduling DCI and exchange data with the network entity 710. The UE 720 may then return to a sleep state, which involves switching off the main radio 724 and switching on the LP WUR 722.

There are differences between a PDCCH-based WUS for the main radio 724 and the LP WUS 726. The LP WUS 726 may not be based on PDCCH monitoring, as the LP WUR 722 may only support a limited set of power efficient operations. For a PDCCH-based WUS, information about the set of carriers for which the UE 720 wakes up the main radio 724 is indicated by the PDCCH payload. For the LP WUS 726, the information may be indicated by one of multiple candidate WUSs, which may each be a sequence of bits.

As indicated above, FIG. 7 is provided as an example. Other examples may differ from what is described with regard to FIG. 7.

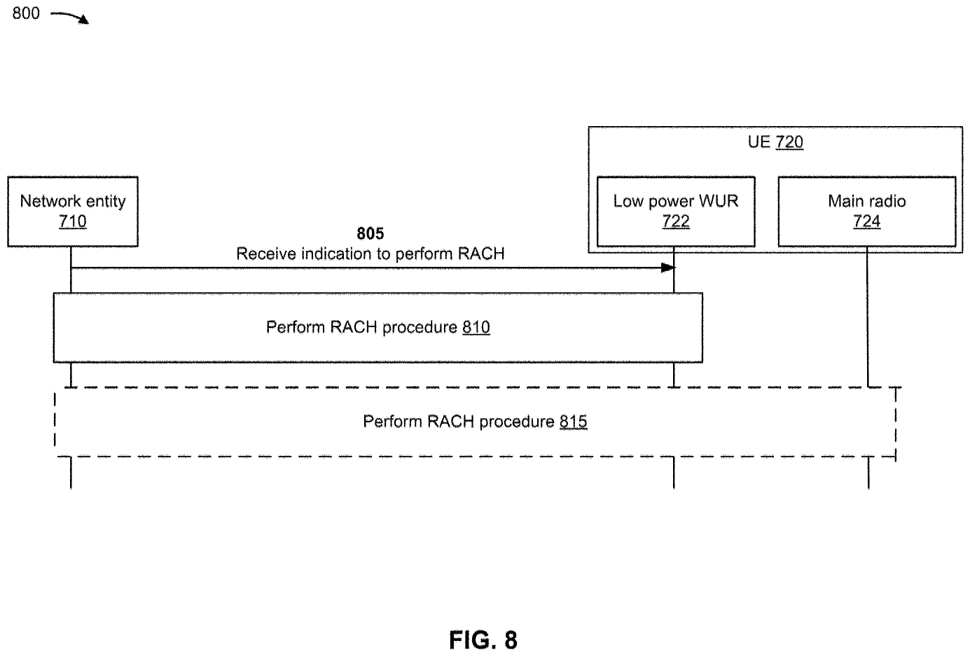

FIG. 8 is a diagram illustrating an example 800 of using an LP WUR for additional functionality, in accordance with the present disclosure.

In an inactive mode, the UE 720 may be asked to perform a RACH procedure and/or paging monitoring. According to various aspects described herein, if the UE 720 is already in a deep sleep and operating its LP WUR 722, the LP WUR 722 may be used to initiate and/or perform the RACH procedure. The UE 720 may use the LP WUR 722 to transmit and receive some RACH signaling. For example, as shown by reference number 805, the UE 720 may receive, at a second radio (e.g., LP WUR 722), an indication to perform a RACH procedure using the LP WUR 722 or a first radio (e.g., main radio 724). The UE 720 may perform the RACH procedure based at least in part on the indication. For example, as shown by reference number 810, the UE 720 may perform the RACH procedure using the LP WUR 722. The RACH procedure may be performed as described in connection with FIG. 4 or FIG. 5. Alternatively, as shown by reference number 815, the main radio 724 may perform the RACH procedure. By using the LP WUR for additional functionality, such as for RACH procedures, the UE 720 may conserve more power.

In some aspects, the LP WUR 722 may perform the RACH procedure based at least in part on a configuration for an LP WUR for performing a RACH procedure. The configuration may be associated with a capability of the UE to use the LP WUR 722 to transmit and receive RACH messages. In some aspects, the configuration may include beam search information, where beam thresholds may be higher for the LP WUR 722 than for the main radio 724 (e.g., lower quality signaling expected for LP WURs). The configuration may also include power control information for RACH procedures, a low power reference signal threshold (e.g., rsrp-ThresholdCSI-RS), a signal strength (e.g., RSRP) threshold for selection of an SSB for 4-step random access type (e.g., rsrp-ThresholdSSB), and/or a signal strength (e.g., RSRP) threshold for selection between a normal uplink (NUL) carrier and a supplementary uplink (SUL) carrier (e.g., rsrp-ThresholdSSB-SUL). The configuration may indicate an initial RA preamble power (e.g., preambleReceivedTargetPower), a power ramping factor for preamble retransmissions (e.g., powerRampingStep), a maximum quantity of preamble transmissions (e.g., preambleTransMax) or retransmissions, a power ramping factor (e.g., powerRampingStep, for RACH procedures), and/or a power ramping factor for a prioritized RACH procedure (e.g., powerRampingStepHighPriority). The configuration may include a scaling factor for a prioritized RACH procedure (e.g., scalingFactorBI). The configuration may define PRACH occasion(s) associated with an SSB in which the MAC entity may transmit an RA preamble (e.g., ra-ssb-OccasionMaskIndex) and/or define PRACH occasion(s) associated with a CSI-RS in which the MAC entity may transmit an RA preamble (e.g., ra-OccasionList). The configuration may include other parameters, including PREAMBLE RECEIVED TARGET POWER to preambleReceivedTargetPower+DELTA PREAMBLE+(PREAMBLE_POWER_RAMPING_COUNTER−1)×PREAMBLE POWER RAMPING STEP.

In some aspects, the network entity 710 may transmit the indication to perform a RACH procedure (and type of RACH and QCL relations) in connected mode, if the UE 720 is configured or is using the LP-WUR 722 while the main radio 724 is in active or sleep mode.

The UE 720 may monitor for SSBs and then select the RACH occasion and which filter or analog beam is to be used based at least in part on the SSB. Then, the UE 720 may use the analog beams or antenna ports used for receiving the best SSB to receive and transmit other RACH messages. In connected mode, as an example, the network entity 710 may transmit DCI indicating the TCI state (which defines the QCL relation) between a PDSCH signal and a reference signal (e.g., notifies the UE 720 to receive the PDSCH using the same spatial beam or analog filter and/or ports used to receive a downlink reference signal (e.g., SSB or CSI-RS) or to receive the PDSCH using the same spatial beam or analog filter and/or ports used to transmit an uplink reference signal (e.g., sounding reference signal (SRS)). In a similar manner, the UE 720 is obtain a QCL source or beam correspondence.

In some aspects, the configuration may include (or the network entity 710 may otherwise indicate) one or more QCL sources and/or a QCL type for one or more of RACH messages, including RACH messages transmitted or received using the LP WUR 722. The QCL type may be QCL Type-D, which defines the spatial receive or transmit beam/filter. Other QCL types include QCL Type A (for Doppler shift, Doppler spread, average delay, and delay spread), QCL Type B (for Doppler shift and Doppler spread), or QCL Type C (for average delay and Doppler shift). There may be a QCL source for reception and a QCL source for transmission. There may be a QCL source for each RACH message in a RACH procedure

The network entity 710 may indicate the QCL source and/or QCL type for RACH messages in one or more of low power signals (e.g., LP-WUS or LP signal indicating initiating the RACH procedure). In some aspects, the UE 720 may determine the QCL source and/or QCL type for the one or more RACH messages through monitoring at least one of the reference signals by the main radio 724 or one or more of reference signals by the LP-WUR 722 or a combination thereof. If this information is indicated to the UE 720, there could be multiple defined uplink and downlink reference signals by at least the main radio 724 or the LP WUR 722 and multiple defined TCI states, wherein one or more of TCI states are selected for the one or more of RACH messages. The QCL sources and/or QCL types for the one or more RACH messages may be signaled in an LP-WUS explicitly (e.g., in form of at least of reference signal identifier (ID) of one or more of previously configured reference signals used for downlink or uplink and monitored by the main radio 724 or the LP WUR 722 and type (e.g., Type D since it is a spatial beam/filter). The one or more QCL sources and/or QCL type may be configured or indicated during a connected mode of the UE 720.

In some aspects, the UE 720 may monitor for an SSB with the main radio 724 or monitor for an LP synchronization signal (LP-SS) with the LP-WUR 722. The UE 720 may determine one or more QCL sources and/or a QCL type for one or more RACH messages based at least in part on the SSB or the LP-SS. The UE 720 has been able to make some determinations based on RSRP or RSRQ measurements on an SSB, CSI-RS, downlink reference signals, or uplink reference signals monitored by the main radio 724. In some aspects associated with the LP WUR 722, the UE 720 may determine one or more QCL sources and/or a QCL type for one or more RACH messages based at least in part on an LP-RS, LP-SS measurements measured by the LP-WUR 722 (e.g., RSRP/RSRQ/SINR or other channel metric defined for LP-WURs), SSB/CSI-RS measurements performed by the main radio 724 (when the main radio 724 is active), or an indication to use downlink and/or uplink reference signals monitored by the main radio 724, the LP WUR 722, or a combination thereof.

In some aspects, the main radio 724 may monitor for a new SSB after waking up and monitoring some SSBs. The UE 720 determine the QCL source and/or QCL type for RACH messages based at least in part on the new SSB. The UE 720 may use a previously configured uplink or downlink reference signal monitored by the main radio 724 or the LP WUR 722 to determine the QCL source and/or QCL type for RACH messages. The network entity 710 may indicate the QCL source and/or QCL type for RACH messages in an LP-WUS to trigger a RACH procedure or to wake up the main radio 724. In some aspects, the UE 720 may use any combination of the above method for determining the QCL source and/or the QCL type for the one or more RACH messages.

In some aspects, the QCL source used for RACH messages may be applied when the UE 720 wakes up and monitors for SSBs and then performs a RACH procedure (e.g., scenarios where the LP-WUR 722 is just receiving an indication to wake up the main radio 724 to monitor in a paging occasion and then perform the RACH procedure. In such scenarios, the indication of the QCL or which QCL source to use is either explicit or implicit. The QCL sources may be used regardless of whether the UE 720 uses the main radio 724 to perform the RACH procedure or uses the LP-WUR 722 to perform the RACH procedure.

In some aspects, the QCL source(s) may differ based on which radio is used for RACH. In some aspects, the network entity 710 may indicate which type of RACH (e.g., 2-stage RACH or 4-stage RACH) is used by the LP WUR 722 or the main radio 724. The indication may be carried on at least one of the LP signals (e.g., LP-WUS, new LP signal, one or more of LP-SS or LP-RS, or a combination thereof). In some aspects, the type of RACH may be configured using the main radio 724 before the UE 720 starts to monitor signals using the LP-WUR 722 or whenever the main radio 724 is active and monitoring signals. In some aspects, the type of RACH may depend on the time duration where the main radio 724 is off or at very low power states (e.g., ultra-low power state). Based at least in part on a configuration during a connected mode or when the main radio 724 is ON or active to monitor signals, the network entity 710 may configure a certain time threshold(s) that maps to a certain RACH type.

In some aspects, the network entity 710 may indicate LP WUR parameters (e.g., via L1, L2, or L3 signaling) to the LP WUR 722 or the main radio 724. The network entity 710 may indicate LP WUR parameters in a main radio WUS or in an LP WUS. The network entity 710 may indicate LP WUR parameters in a new LP indication or using initial access messages such as an SSB (e.g., PBCH (MIB)), an SIB1 (e.g., SIB1 PDSCH, SIB1, PDCCH (DCI)), or other SIB (OSIB) (e.g., OSIB PDCCH, OSIB PDSCH). The network entity 710 may indicate LP WUR parameters in RACH signaling, such as in 4-step RACH messages (e.g., Msg2, RAR PDCCH, PDSCH, Msg4, PDCCH (DCI)) or in 2-step RACH messages (e.g., MsgB PDCCH (DCI), PDSCH).

In some aspects, the UE 720 may receive an indication for a RACH procedure (e.g., PDCCH order-like signal) in an LP WUS, where the LP WUS includes an on-off-keying (OOK) signal, a sequence-based signal, or a coded signal. The LP WUS may use a format compatible with the LP WUR 722. The LP WUS may be an LP WUS order for RACH. The main radio 724 may wake up after a specified time duration (e.g., X time units) to perform a RACH procedure, where the time duration or X may be configured separately or as part of the LP WUS order. The LP WUR 722 may transmit a RACH message with specified open loop power parameters.

In some aspects, the UE 720 may perform the RACH procedure using RACH occasions that are based at least in part on an index in an SSB. The UE 720 may select the SSB based at least in part on a signal strength of the SSB or a signal strength of an associated low power reference signal. That is, the UE 720 may monitor for an SSB to obtain an index for a RACH occasion, and the UE 720 may use a threshold for an CSI-RS or an SSB to obtain an SSB and an index for a RACH occasion.

The UE 720 may use a CSI-RS or an SSB (which may be an LP reference signal (LP-RS) or an LP-SS to determine RACH occasions. The UE 720 may use different thresholds for determining which LP-SS is best (e.g., highest signal strength, highest reliability, highest signal-to-noise ratio (SNR). An LP-RS may have a subset of configurations similar to SSB for the main radio 724. The UE 720 may select an LP-RS or an LP-SS with CSI-RSRP or SS-RSRP above a signal threshold (e.g., rsrp-ThresholdLP-RS/LP-SS) among the associated LP-RSs, and then select the corresponding RA resources.

In some aspects, the UE 720 may perform the RACH procedure after receiving an RAR that indicates configuration information for the RACH procedure. The UE 720 may receive an RAR that indicates when the first radio main radio 724 is to wake up in association with the RACH procedure. There may be a time to enable the main radio 724 to process X slots/symbols/time units from the RACH procedure. The indication to perform the RACH procedure may indicate one or more candidate sequences to trigger the RACH procedure for one or more component carriers (CCs). LP WUR behavior may be indicated via Layer 1 (L1), Layer 2 (L2), or Layer 3 (L3) signaling before monitoring for the LP WUS.

In some aspects, the network entity 710 may indicate to the LP WUR 722, through an LP WUS or new signaling for the LP WUR 722 or an LP WUS order, multiple candidate sequences to trigger a RACH procedure on one or more of multiple carriers.

As indicated above, FIG. 8 is provided as an example. Other examples may differ from what is described with regard to FIG. 8.

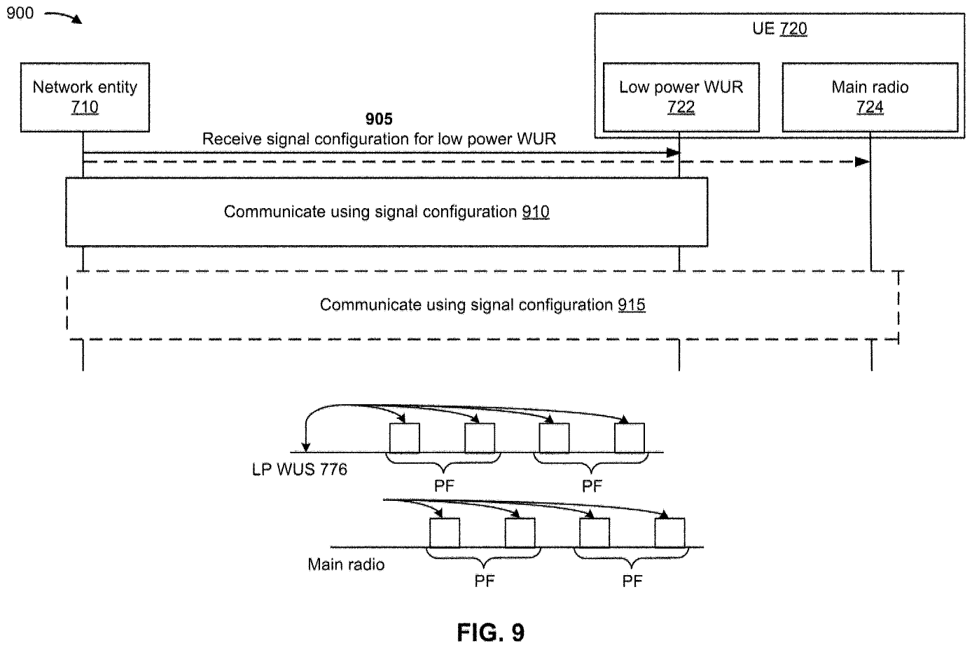

FIG. 9 is a diagram illustrating an example 900 of using signal configuration for an LP WUR, in accordance with the present disclosure.

In some aspects, the LP WUR 722 may be configured to perform other operations. Example 900 shows configuring the UE 720 for other operations. As shown by reference number 905, the UE 720 may receive a signal configuration for the LP WUR 722. The LP WUR 722 may receive the signal configuration in a WUS, such as an LP WUS, or in another signal that is specific to LP WURs. The LP WUS may indicate a UE wake up availability. In some aspects, the main radio 724 may receive the signal configuration that is directed to the LP WUR 722.

In some aspects, the signal configuration may enable the LP WUR 722 to operate with the UE 720 in an inactive mode to utilize additional receive and transmit functionalities (e.g., paging monitoring, tracking reference signal (TRS) availability) for more efficient power reduction. For example, the signal configuration may configure the LP WUR 722 to monitor for a paging indication from the network entity 710 while the main radio 724 is off for UE power savings. In some aspects, the UE 720 may receive an indication (in the signal configuration or another message) to monitor a next paging occasion (PO) using the LP WUR 722 or the main radio 724. The next PO may be based at least in part on a UE preference or an ability of the UE at the time. The signal configuration may change a monitoring occasion or select a configuration from among multiple configurations.

In some aspects, the signal configuration may indicate POs for the UE to monitor using the LP WUR 722 or the main radio 724. The signal configuration may indicate (e.g., via an LP WUS) whether the main radio 724 is to monitor POs of the main radio 724 (POs compatible with main radio 724) or to monitor the LP WUR 722 using POs of LP WUR 722. The LP WUR 722 and the main radio 724 may have different signal configurations.

In some aspects, a configuration for a paging signal or a paging format may change based at least in part on which radio receives the signal configuration. The LP WUR 722 may use OOK-based waves (e.g., OFDM, single carrier, or other waveforms) or OFDM-based waveforms (e.g., PDCCH, sequence based). The LP WUR 722 may use similar waveforms as the main radio 724 based at least in part on a UE capability (e.g., PDCCH, sequence based) while the main radio 724 uses OFDM-based waveforms.

In some aspects, the signal configuration (e.g., in an LP WUS) may indicate a TRS availability. A TRS for an idle/inactive mode UE may provide the UE with additional reference signal opportunities for a tracking loop update, and denser reference signal occasions allow the UE 720 to quickly update its tracking loops to have longer total deep sleep time and thus consume less power. TRS availability may be indicated by 1 bit for 1 group of TRS resource sets. Once the bit is set to 1, the UE 720 may expect that the TRS group will be available for a configured duration. An SIB may provide a configuration of the TRS resource and occasions, and L1 signaling may provide availability information for a TRS occasion. A configured TRS may be indicated as available if the TRS is transmitted by the network entity 710 at configured occasions.

In some aspects, the signal configuration may include a TRS configuration that indicates whether the UE 720 is to wake up the main radio 724 to monitor for TRSs or to use the LP WUR 722 to monitor for TRSs when there are TRSs configured with waveforms or modulations that are compatible with LP WUR capability. The signal configuration may indicate that the LP WUR 722 is to use a particular TRS configuration. The TRS configuration may indicate an offset for the TRS. The format of a TRS may change based at least in part on what the network entity 710 indicates in the TRS configuration.

The signal configuration may indicate which radio is to handle TRSs, and the TRS configuration may be parameterized by a radio. The LP WUR TRS may be the same or different than the main radio TRS, and thus the TRS configuration for the LP WUR 722 may be different than the TRS configuration for the main radio 724. A TRS configuration may include a bit or a parameter to indicate whether the TRS configuration is for an LP WUR TRS or for a main radio TRS.

As shown by reference number 910, the network entity 710 and the LP WUR 722 may communicate using the signal configuration. This may include paging monitoring, monitoring for TRSs, or another operation by the LP WUR 722. As shown by reference number 915, the network entity 710 and the main radio 724 may communicate using the signal configuration. This may involve operations that are configured via the LP WUR 722 or operations that involve coordination with the LP WUR 722.

In some aspects, the bit or parameter in the TRS configuration may be shared by a TRS in a TRS resource set or in a group of TRS resource sets. LP WUR TRSs and main radio TRSs may be configured in separate groups of TRS resource sets. In a group of TRS resource sets, the LP WUS 726 or other LP WUR signal may only indicate that the UE 720 is to use the LP TRS or the main radio TRS, if the network entity 710 only sends a single sequence as the LP WUS. For a TRS resource set, the LP WUS may indicate that an LP TRS and a main radio TRS are available by a single LP WUS sequence. The LP WUS may indicate both a UE wake up and TRS availability with a specific LP WUS sequence. For example, a TRS may be available only when the UE 720 is to wake up, such as for paging or for a RACH procedure. The signal configuration may implicitly indicate the radio by indicating which TRS resource, TRS resource set, or TRS group of resource sets is triggered or is to be available.

Example 900 shows paging frames (PFs), where each PF includes paging occasions (POS). The network entity 710 may configure LP WUS occasions with certain POs across the same PF or one or more of the PFs. In some aspects, for both POs and TRSs, the occasions or resources to monitor may be indicated by the selection of the radio. For example, the signal configuration may indicate that the LP WUR 722 is to be used, the main radio 724 is to be used, or that the UE 720 may select either radio. If the signal configuration indicates the radio that is to be used, the signal configuration may indicate which occasions to monitor.

By providing a signal configuration for an LP WUR, the UE 720 may be enabled for additional functionality while the main radio is in a sleep mode. As a result, UE power is conserved.

As indicated above, FIG. 9 is provided as an example. Other examples may differ from what is described with regard to FIG. 9.

FIG. 10 is a diagram illustrating an example process 1000 performed, for example, by a UE, in accordance with the present disclosure. Example process 1000 is an example where the UE (e.g., UE 120, UE 720) performs operations associated with signaling for an LP WUR.

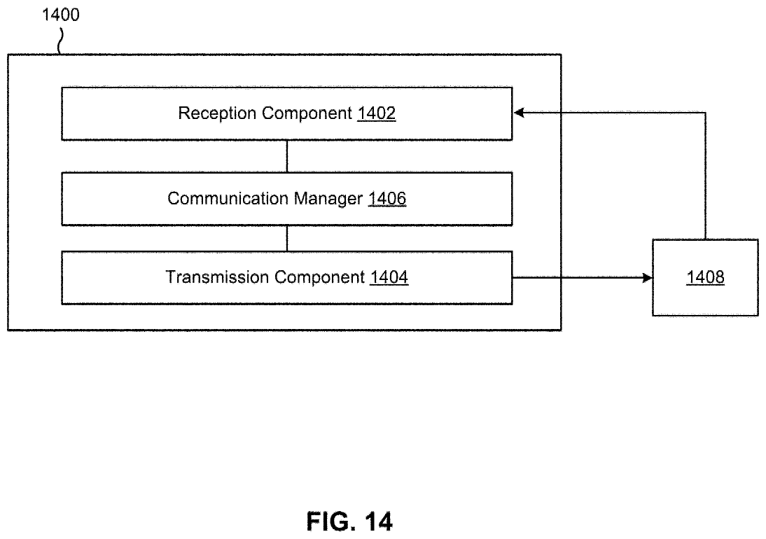

As shown in FIG. 10, in some aspects, process 1000 may include receiving, at a second radio of the UE, an indication to perform a RACH procedure using a first radio (e.g., main radio 724) of the UE or the second radio (e.g., LP WUR 722), where the second radio operates at a lower power than the first radio (block 1010). For example, the UE (e.g., using reception component 1402 and/or communication manager 1406, depicted in FIG. 14) may receive, at a second radio of the UE, an indication to perform a RACH procedure using a first radio of the UE or the second radio, where the second radio operates at a lower power than the first radio, as described above.

As further shown in FIG. 10, in some aspects, process 1000 may include performing the RACH procedure based at least in part on the indication (block 1020). For example, the UE (e.g., using communication manager 1406 depicted in FIG. 14) may perform the RACH procedure based at least in part on the indication, as described above.

Process 1000 may include additional aspects, such as any single aspect or any combination of aspects described below and/or in connection with one or more other processes described elsewhere herein.

In a first aspect, performing the RACH procedure includes performing the RACH procedure using the second radio based at least in part on a configuration for using the second radio for the RACH procedure.

In a second aspect, alone or in combination with the first aspect, the configuration is associated with a capability of the UE to use the second radio to transmit and receive RACH messages.

In a third aspect, alone or in combination with one or more of the first and second aspects, the configuration indicates one or more of beaming search information, powering control information for RACH procedures, a low power reference signal threshold, a signal strength threshold for selection of an SSB, an initial random access preamble power, a power ramping factor for preamble retransmissions, a maximum quantity of preamble transmissions or retransmissions, a power ramping factor for RACH procedures, a power ramping factor for a prioritized RACH procedure, a scaling factor for a prioritized random access procedure, a signal strength threshold for selection between a NUL and a SUL, or a preamble received target power.

In a fourth aspect, alone or in combination with one or more of the first through third aspects, the configuration indicates one or more of a low power reference signal threshold or RACH occasions associated with an SSB. In some aspects, the configuration may indicate one or more QCL sources and/or a QCL type for one or more RACH messages. In some aspects, process 1000 includes determining the one or more QCL sources and/or the QCL type for the one or more RACH messages.

In a fifth aspect, alone or in combination with one or more of the first through fourth aspects, receiving the indication includes receiving the indication in a WUS (e.g., LP WUS) specific to the second radio, and the WUS includes an OOK signal, a sequence-based signal, or a coded signal.

In a sixth aspect, alone or in combination with one or more of the first through fifth aspects, receiving the indication includes receiving the indication in an OOK signal that is specific to LP WURs, a sequence-based signal that is specific to LP WURs, or a coded signal that is specific to LP WURs.

In a seventh aspect, alone or in combination with one or more of the first through sixth aspects, performing the RACH procedure includes performing the RACH procedure based at least in part on a wake up signal order that specifies that the first radio is to wake up after a specified time duration to perform the RACH procedure.

In an eighth aspect, alone or in combination with one or more of the first through seventh aspects, performing the RACH procedure includes performing the RACH procedure based at least in part on a WUS order (e.g., LP WUS order) that specifies that the second radio is to transmit a RACH message using one or more specified open loop power parameters.

In a ninth aspect, alone or in combination with one or more of the first through eighth aspects, performing the RACH procedure includes performing the RACH procedure using RACH occasions that are based at least in part on an index in an SSB.

In a tenth aspect, alone or in combination with one or more of the first through ninth aspects, process 1000 includes selecting the SSB based at least in part on a signal strength of the SSB or a signal strength of an associated low power reference signal.

In an eleventh aspect, alone or in combination with one or more of the first through tenth aspects, performing the RACH procedure includes receiving a random access response that indicates configuration information for the RACH procedure.

In a twelfth aspect, alone or in combination with one or more of the first through eleventh aspects, performing the RACH procedure includes receiving an RAR that indicates when the first radio is to wake up in association with the RACH procedure.

In a thirteenth aspect, alone or in combination with one or more of the first through twelfth aspects, the indication indicates one or more candidate sequences to trigger the RACH procedure for one or more component carriers.

In a fourteenth aspect, alone or in combination with one or more of the first through thirteenth aspects, process 1000 includes receiving parameters for the second radio in an L1, L2, or L3 signaling message.

In a fifteenth aspect, alone or in combination with one or more of the first through fourteenth aspects, process 1000 includes receiving parameters for the second radio in an initial access message.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network entity, in accordance with the present disclosure. Example process 1100 is an example where the network entity (e.g., network node 110, network entity 710) performs operations associated with signaling for an LP WUR.

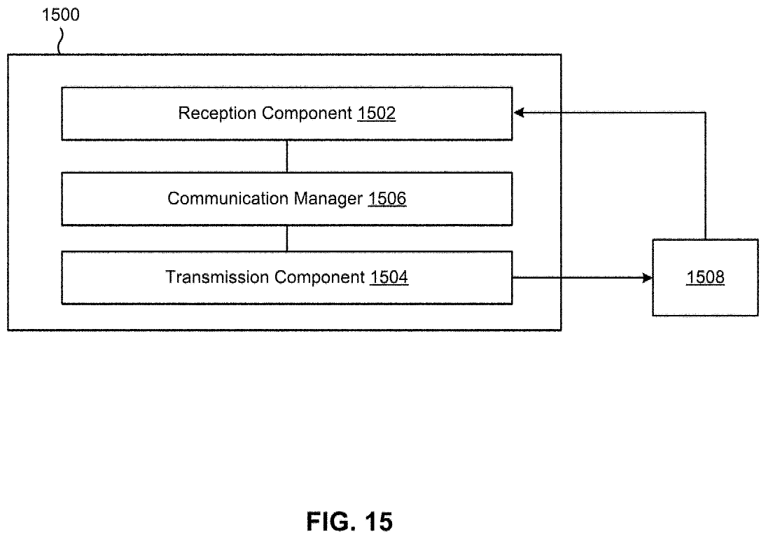

As shown in FIG. 11, in some aspects, process 1100 may include transmitting an indication to perform a RACH procedure using a low power radio (block 1110). For example, the network entity (e.g., using transmission component 1504 and/or communication manager 1506 depicted in FIG. 15) may transmit an indication to perform a RACH procedure using a low power radio, as described above.

As further shown in FIG. 11, in some aspects, process 1100 may include performing the RACH procedure based at least in part on the indication (block 1120). For example, the network entity (e.g., using communication manager 1506 depicted in FIG. 15) may perform the RACH procedure based at least in part on the indication, as described above.

Process 1100 may include additional aspects, such as any single aspect or any combination of aspects described below and/or in connection with one or more other processes described elsewhere herein.

In a first aspect, process 1100 includes transmitting a configuration for using the LP WUR for the RACH procedure.

In a second aspect, alone or in combination with the first aspect, transmitting the indication includes transmitting the indication in an LP WUS for the LP WUR.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 120, UE 720) performs operations associated with signaling for an LP WUR.

As shown in FIG. 12, in some aspects, process 1200 may include receiving a signal configuration for using a second radio of the UE that operates at a lower power than a first radio of the UE (block 1210). For example, the UE (e.g., using reception component 1402 and/or communication manager 1406 depicted in FIG. 14) may receive a signal configuration for using a second radio of the UE that operates at a lower power than a first radio of the UE, as described above.

As further shown in FIG. 12, in some aspects, process 1200 may include communicating using the first radio or the second radio based at least in part on the signal configuration (block 1220). For example, the UE (e.g., using reception component 1402, transmission component 1404, and/or communication manager 1406, depicted in FIG. 14) may communicate using the first radio or the second radio based at least in part on the signal configuration, as described above.

Process 1200 may include additional aspects, such as any single aspect or any combination of aspects described below and/or in connection with one or more other processes described elsewhere herein.

In a first aspect, receiving the signal configuration includes receiving the signal configuration in a WUS (e.g., LP WUS) specific to the second radio or in a signal that is specific to LP WURs.

In a second aspect, alone or in combination with the first aspect, the WUS or the signal that is specific to LP WURs indicates one or more of UE wake up availability or TRS availability.

In a third aspect, alone or in combination with one or more of the first and second aspects, the signal configuration indicates paging occasions for the UE to monitor using the first radio or the second radio.

In a fourth aspect, alone or in combination with one or more of the first through third aspects, process 1200 includes receiving an indication to monitor a next paging occasion using the first radio or the second radio.

In a fifth aspect, alone or in combination with one or more of the first through fourth aspects, communicating using the first radio or the second radio includes communicating using the second radio based at least in part on the signal configuration being received at the second radio.

In a sixth aspect, alone or in combination with one or more of the first through fifth aspects, process 1200 includes receiving another signal configuration at the first radio, and communicating using the first radio based at least in part on the other signal configuration being received at the first radio.

In a seventh aspect, alone or in combination with one or more of the first through sixth aspects, receiving the signal configuration includes receiving the signal configuration in a signal having a waveform decodable by the first radio.

In an eighth aspect, alone or in combination with one or more of the first through seventh aspects, the signal configuration indicates a TRS resource set, and communicating using the first radio or the second radio includes communicating using the first radio based at least in part on the TRS resource set being associated with the first radio or communicating using the second radio based at least in part on the TRS resource set being associated with the second radio.

In a ninth aspect, alone or in combination with one or more of the first through eighth aspects, the signal configuration indicates a TRS configuration and indicates whether the TRS configuration is for the first radio or the second radio.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network entity, in accordance with the present disclosure. Example process 1300 is an example where the network entity (e.g., network node 110, network entity 710) performs operations associated with signaling for an LP WUR.

As shown in FIG. 13, in some aspects, process 1300 may include transmitting a signal configuration that indicates one or more of paging occasions or a tracking reference signal resource set for use with a low power radio (block 1310). For example, the network entity (e.g., using transmission component 1504 and/or communication manager 1506 depicted in FIG. 15) may transmit a signal configuration that indicates one or more of paging occasions or a TRS resource set for use with an LP WUR, as described above.

As further shown in FIG. 13, in some aspects, process 1300 may include communicating based at least in part on the signal configuration (block 1320). For example, the network entity (e.g., using reception component 1502 transmission component 1504, and/or communication manager 1506 depicted in FIG. 15) may communicate based at least in part on the signal configuration, as described above.

Process 1300 may include additional aspects, such as any single aspect or any combination of aspects described below and/or in connection with one or more other processes described elsewhere herein.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE (e.g., UE 120, UE 720), or a UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 140 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 1-9. Additionally, or alternatively, the apparatus 1400 may be configured to perform one or more processes described herein, such as process 1000 of FIG. 10, process 1200 of FIG. 12, or a combination thereof. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

In some aspects, the reception component 1402 may receive, at a second radio of the UE, an indication to perform a RACH procedure using a first radio of the UE or the second radio, where the second radio operates at a lower power than the first radio. The communication manager 1406 may perform the RACH procedure based at least in part on the indication.

The communication manager 1406 may select the SSB based at least in part on a signal strength of the SSB or a signal strength of an associated low power reference signal. The reception component 1402 may receive parameters for the second radio in an L1, L2, or L3 signaling message. The reception component 1402 may receive parameters for the second radio in an initial access message.

In some aspects, the reception component 1402 may receive a signal configuration for using a second radio of the UE that operates at a lower power than a first radio of the UE. The reception component 1402 and/or the transmission component 1404 may communicate using the first radio or the second radio based at least in part on the signal configuration.

The reception component 1402 may receive an indication to monitor a next paging occasion using the first radio or the second radio. The reception component 1402 may receive another signal configuration at the first radio. The communication manager 1406 may communicate using the first radio based at least in part on the other signal configuration being received at the first radio.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network entity (e.g., network node 110, network entity 710), or a network entity may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 1-9. Additionally, or alternatively, the apparatus 1500 may be configured to perform one or more processes described herein, such as process 1100 of FIG. 11, process 1300 of FIG. 13, or a combination thereof. In some aspects, the apparatus 1500 and/or one or more components shown in FIG. 15 may include one or more components of the network entity described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network entity described in connection with FIG. 2.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, a modem, a modulator, a transmit MIMO processor, a transmit processor, a controller/processor, a memory, or a combination thereof, of the network entity described in connection with FIG. 2. In some aspects, the transmission component 1504 may be co-located with the reception component 1502 in a transceiver.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

In some aspects, the transmission component 1504 may transmit an indication to perform a RACH procedure using a low power radio (e.g., LP WUR 722). The communication manager 1506 may perform the RACH procedure based at least in part on the indication. The transmission component 1504 may transmit a configuration for using the low power radio for the RACH procedure.

In some aspects, the transmission component 1504 may transmit a signal configuration that indicates one or more of paging occasions or a TRS resource set for use with a low power radio. The reception component 1502 and/or the transmission component 1504 may communicate based at least in part on the signal configuration.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving, at a second radio of the UE, an indication to perform a random access channel (RACH) procedure using a first radio of the UE or the second radio, wherein the second radio operates at a lower power than the first radio; and performing the RACH procedure based at least in part on the indication.

Aspect 2: The method of Aspect 1, wherein performing the RACH procedure includes performing the RACH procedure using the second radio based at least in part on a configuration for using the second radio for the RACH procedure.

Aspect 3: The method of Aspect 2, wherein the configuration is associated with a capability of the UE to use the second radio to transmit and receive RACH messages.

Aspect 4: The method of Aspect 2, wherein the configuration indicates one or more of: beam search information, power control information for RACH procedures, a low power reference signal threshold, a signal strength threshold for selection of a synchronization signal block, an initial random access preamble power, a power ramping factor for preamble retransmissions, a maximum quantity of preamble transmissions or retransmissions, a power ramping factor for RACH procedures, a power ramping factor for a prioritized RACH procedure, a scaling factor for a prioritized random access procedure, a signal strength threshold for selection between a normal uplink carrier and a supplemental uplink carrier, or a preamble received target power.

Aspect 5: The method of Aspect 2, wherein the configuration indicates one or more of a low power reference signal threshold or RACH occasions associated with a synchronization signal block.

Aspect 6: The method of Aspect 2, wherein the configuration indicates one or more of at least one quasi-co-location (QCL) source for one or more RACH messages or a QCL type for the one or more RACH messages, or the method includes determining the one or more of the at least one QCL source for the one or more RACH messages or the QCL type for the one or more RACH messages.

Aspect 7: The method of any of Aspects 1-6, wherein receiving the indication includes receiving the indication in a wake up signal (WUS) specific to the second radio, and wherein the WUS includes an on-off-keying signal, a sequence-based signal or a coded signal.

Aspect 8: The method of any of Aspects 1-7, wherein receiving the indication includes receiving the indication in an on-off-keying signal that is specific to low power radios, a sequence-based signal that is specific to low power radios, or a coded signal that is specific to low power radios.

Aspect 9: The method of any of Aspects 1-8, wherein performing the RACH procedure includes performing the RACH procedure based at least in part on a wake up signal order that specifies that the first radio is to wake up after a specified time duration to perform the RACH procedure.

Aspect 10: The method of any of Aspects 1-9, wherein performing the RACH procedure includes performing the RACH procedure based at least in part on a wake up signal order that specifies that the second radio is to transmit a RACH message using one or more specified open loop power parameters.

Aspect 11: The method of any of Aspects 1-10, wherein performing the RACH procedure includes performing the RACH procedure using RACH occasions that are based at least in part on an index in a synchronization signal block (SSB).

Aspect 12: The method of Aspect 11, further comprising selecting the SSB based at least in part on a signal strength of the SSB or a signal strength of an associated low power reference signal.

Aspect 13: The method of any of Aspects 1-12, wherein performing the RACH procedure includes receiving a random access response that indicates configuration information for the RACH procedure.

Aspect 14: The method of any of Aspects 1-13 wherein performing the RACH procedure includes receiving a random access response that indicates when the first radio is to wake up in association with the RACH procedure.

Aspect 15: The method of any of Aspects 1-14, wherein the indication indicates one or more candidate sequences to trigger the RACH procedure for one or more component carriers.

Aspect 16: The method of any of Aspects 1-15, further comprising receiving parameters for the second radio in a Layer 1, Layer 2, or Layer 3 signaling message.

Aspect 17: The method of any of Aspects 1-16, further comprising receiving parameters for the second radio in an initial access message.

Aspect 18: A method of wireless communication performed by a network entity, comprising: transmitting an indication to perform a random access channel (RACH) procedure using a low power radio; and performing the RACH procedure based at least in part on the indication.

Aspect 19: The method of Aspect 18, further comprising transmitting a configuration for using the low power radio for the RACH procedure.

Aspect 20: The method of any of Aspects 18-19, wherein transmitting the indication includes transmitting the indication in a low power wake up signal (WUS) for the low power radio.

Aspect 21: A method of wireless communication performed by a user equipment (UE), comprising: receiving a signal configuration for using a second radio of the UE that operates at a lower power than a first radio of the UE; and communicating using the first radio or the second radio based at least in part on the signal configuration.

Aspect 22: The method of Aspect 21, wherein receiving the signal configuration includes receiving the signal configuration in a wake up signal (WUS) specific to the second radio or in a signal that is specific to low power radios.

Aspect 23: The method of Aspect 22, wherein the WUS or the signal that is specific to low power radios indicate one or more of UE wake up availability or tracking reference signal availability.

Aspect 24: The method of any of Aspects 21-23, wherein the signal configuration indicates paging occasions for the UE to monitor using the first radio or the second radio.

Aspect 25: The method of any of Aspects 21-24, further comprising receiving an indication to monitor a next paging occasion using the first radio or the second radio.

Aspect 26: The method of any of Aspects 21-25, wherein communicating using the first radio or the second radio includes communicating using the second radio based at least in part on the signal configuration being received at the second radio.

Aspect 27: The method of any of Aspects 21-26, further comprising: receiving another signal configuration at the first radio; and communicating using the first radio based at least in part on the other signal configuration being received at the first radio.

Aspect 28: The method of any of Aspects 21-27, wherein receiving the signal configuration includes receiving the signal configuration in a signal having a waveform decodable by the first radio.

Aspect 29: The method of any of Aspects 21-28, wherein the signal configuration indicates a tracking reference signal (TRS) resource set, and wherein communicating using the first radio or the second radio includes communicating using the first radio based at least in part on the TRS resource set being associated with the first radio or communicating using the second radio based at least in part on the TRS resource set being associated with the second radio.

Aspect 30: The method of any of Aspects 21-29, wherein the signal configuration indicates a tracking reference signal (TRS) configuration and indicates whether the TRS configuration is for the first radio or the second radio.

Aspect 31: A method of wireless communication performed by a network entity, comprising: transmitting a signal configuration that indicates one or more of paging occasions or a tracking reference signal resource set for use with a low power radio; and communicating based at least in part on the signal configuration.

Aspect 32: An apparatus for wireless communication at a device, comprising a processor; memory coupled with the processor; and instructions stored in the memory and executable by the processor to cause the apparatus to perform the method of one or more of Aspects 1-31.

Aspect 33: A device for wireless communication, comprising a memory and one or more processors coupled to the memory, the one or more processors configured to perform the method of one or more of Aspects 1-31.

Aspect 34: An apparatus for wireless communication, comprising at least one means for performing the method of one or more of Aspects 1-31.

Aspect 35: A non-transitory computer-readable medium storing code for wireless communication, the code comprising instructions executable by a processor to perform the method of one or more of Aspects 1-31.

Aspect 36: A non-transitory computer-readable medium storing a set of instructions for wireless communication, the set of instructions comprising one or more instructions that, when executed by one or more processors of a device, cause the device to perform the method of one or more of Aspects 1-31.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive, at a second radio of the UE, an indication to perform a random access channel (RACH) procedure using a first radio of the UE or the second radio, wherein the second radio operates at a lower power than the first radio; and
perform the RACH procedure based at least in part on the indication.

2. The UE of claim 1, wherein the one or more processors, to perform the RACH procedure, are configured to perform the RACH procedure using the second radio based at least in part on a configuration for using the second radio for the RACH procedure.

3. The UE of claim 2, wherein the configuration is associated with a capability of the UE to use the second radio to transmit and receive RACH messages.

4. The UE of claim 2, wherein the configuration indicates one or more of:
beam search information,
power control information for RACH procedures,
a RACH type, either 2-step RACH or 4-step RACH,
a low power reference signal threshold,
a signal strength threshold for selection of a synchronization signal block,
an initial random access preamble power,
a power ramping factor for preamble retransmissions,
a maximum quantity of preamble transmissions or retransmissions,
a power ramping factor for RACH procedures,
a power ramping factor for a prioritized RACH procedure,
a scaling factor for a prioritized random access procedure,
a signal strength threshold for selection between a normal uplink carrier and a
supplemental uplink carrier, or
a preamble received target power.

5. The UE of claim 2, wherein the configuration indicates one or more of at least one quasi-co-location (QCL) source for one or more RACH messages or a QCL type for the one or more RACH messages, or the one or more processors are configured to determine the one or more of the at least one QCL source for the one or more RACH messages or the QCL type for the one or more RACH messages.

6. The UE of claim 2, wherein the configuration indicates one or more of a low power reference signal threshold or RACH occasions associated with a synchronization signal block.

7. The UE of claim 1, wherein the one or more processors, to receive the indication, are configured to receive the indication in a wake up signal (WUS) specific to the second radio, and wherein the WUS includes an on-off-keying signal, a sequence-based signal, or a coded signal.

8. The UE of claim 1, wherein the one or more processors, to receive the indication, are configured to receive the indication in an on-off-keying signal that is specific to low power radios, a sequence-based signal that is specific to low power radios, or a coded signal that is specific to low power radios.

9. The UE of claim 1, wherein the one or more processors, to perform the RACH procedure, are configured to perform the RACH procedure based at least in part on a wake up signal order that specifies that the first radio is to wake up after a specified time duration to perform the RACH procedure.

10. The UE of claim 1, wherein the one or more processors, to perform the RACH procedure, are configured to perform the RACH procedure based at least in part on a wake up signal order that specifies that the second radio is to transmit a RACH message using one or more specified open loop power parameters.

11. The UE of claim 1, wherein the one or more processors, to perform the RACH procedure, are configured to perform the RACH procedure using RACH occasions that are based at least in part on an index in a synchronization signal block (SSB).

12. The UE of claim 11, wherein the one or more processors are configured to select the SSB based at least in part on a signal strength of the SSB or a signal strength of an associated low power reference signal.

13. The UE of claim 1, wherein the one or more processors, to perform the RACH procedure, are configured to receive a random access response that indicates configuration information for the RACH procedure.

14. The UE of claim 1, wherein the one or more processors, to perform the RACH procedure, are configured to receive a random access response that indicates when the first radio is to wake up in association with the RACH procedure.

15. The UE of claim 1, wherein the indication indicates one or more candidate sequences to trigger the RACH procedure for one or more component carriers.

16. The UE of claim 1, wherein the one or more processors are configured to receive parameters for the second radio in an initial access message.

17. A network entity for wireless communication, comprising:
a memory; and
one or more processors, coupled to the memory, configured to:
transmit an indication to perform a random access channel (RACH) procedure using a low power radio; and
perform the RACH procedure based at least in part on the indication.

18. The network entity of claim 17, wherein the one or more processors are configured to transmit a configuration for using the low power radio for the RACH procedure.

19. The network entity of claim 17, wherein the one or more processors, to transmit the indication, are configured to transmit the indication in a low power wake up signal (WUS) for the low power radio.

20. A user equipment (UE) for wireless communication, comprising:
a memory; and
one or more processors, coupled to the memory, configured to:
receive a signal configuration for using a second radio of the UE that operates at a lower power than a first radio of the UE; and
communicate using the first radio or the second radio based at least in part on the signal configuration.

21-30. (canceled)
